(19) United States
(12) Patent Application Publication
(10) Pub. No.: US 2004/0258797 A1
(43) Pub. Date: Dec. 23, 2004

(54) Sugarfree chewing-gum tablet and process for the preparation thereof

(76) Inventors: Guillaume Ribadeau-Dumas, Verlinghem (FR); Gregory Le Bihan, La Frenaye (FR); Bruno Dauchy, Lestrem (FR)

Correspondence Address: STURM & FIX LLP, 206 SIXTH AVENUE, SUITE 1213, DES MOINES, IA, 50309-4076, US

(21) Appl. No.: 10/853,414

(22) Filed: May 25, 2004

(30) Foreign Application Priority Data
May 27, 2003 (FR) 03 06406

(51) Int. Cl. A23G 3/30

(52) U.S. Cl. 426/3

(57) ABSTRACT

The invention relates to a sugarfree chewing-gum tablet comprising more than 25% by weight of gum base and a powdered sweetener comprising at least 40%, and preferably at least 50%, by weight of powdered sorbitol, which does not disintegrate, does not crumble and does not break up when chewing begins.

The invention relates to a tableted chewing-gum.

More precisely, the invention relates to a sorbitol-based sugarfree chewing-gum tablet which does not disintegrate, does not crumble and does not break up when chewing begins.

The invention also relates to a process for preparing such tablets.

Chewing-gums or bubble-gums are provided in a large variety of forms, for example in the form of sticks, of balls or of dragees. For a few years, a new tendency has been to propose chewing-gums which are provided in the form of tablets.

Chewing-gum tablets obtained by compressing powdered excipients are generally characterized by a hard and brittle texture, and disintegrate when they are bitten into, which gives a grainy feeling in the mouth.

Chewing-gum tablets obtained by compression of powder generally have a very homogeneous appearance, which can be difficult to differentiate from a chewing-gum obtained according to a process other than compression. However, they always have a vertical ridge that varies in size but is visible, which is not the case of chewing-gum sticks obtained by rolling a paste, or chewing-gum pads or balls which may or may not be sugar-coated.

Many problems can emerge in the production of chewing gum tablets, such as, for example, poor flow of the chewing-gum powder, adhesion to the punches or cleavage of the tablets, the compressibility and the flow of the powder being essential criteria for the process to run smoothly. These problems are generally solved by optimizing the powder to be compressed and/or by using technological assistance.

Conventional chewing-gum compositions are difficult to use as they are for producing tablets, mainly because the mixing of the ingredients of these formulations in Z-arm mixers heated to between 50 and 80° C. according to the process conventionally used by chewing-gum manufacturers does not result in the production of a requisite powder for direct compression.

It is therefore necessary to adapt the compositions and the conventional production processes to this novel form of confectionery.

It has been proposed, in particular in U.S. Pat. No. 4,000,321, to freeze the chewing-gum preparation in order to be able to readily mill it and compress it. This technique requires, however, specific equipment other than the conventional presses.

Another method consists in preparing chewing-gum formulations with a low water content, using the granulation technique. This technique is in particular described in patent EP 151,344. Thus, it has been possible to preparing chewing-gum tablets using various ingredients, and in particular compressible sugars.

However, it has never been possible to produce sugarfree chewing-gum tablets, using a limited number of ingredients, obtained simply and economically and exhibiting satisfactory organoleptic qualities.

Document WO 02/078459 describes chewing-gum tablets comprising a gum base and a sugar or a polyol, and having the characteristic of disintegrating, breaking up or crumbling when chewing begins and then changing to an elastic texture later on during chewing.

This granular, powdery texture, also referred to as “crumbly” by those skilled in the art, resulting from the disintegration and the crumbling of the chewing-gum tablet when chewing begins is not necessarily sought by the consumer, who desires the usual characteristics of a chewing-gum without the displeasure of a sandy or grainy feeling in the mouth.

Document WO 03/011045 describes sugarfree chewing-gum tablets prepared from a heterogeneous mixture of particles of gum base of large granulometry and of compressible excipients. The tablets obtained are not, however, homogeneous, and there may be a risk of the powder used to produce them demixing due to its heterogeneity.

Other formulations, using relatively expensive excipients, also exist on the market. This is in particular the case of chewing-gum powders comprising mainly isomalt as sweetener, such as the powders sold by Cafosa Spa, under the name All In Gum SF and All In Gum SF+. These powders contain approximately 6 to 10% of sorbitol and 60 to 90% of isomalt. Other tablets with a high isomalt content are also proposed by Schuster Marketing under the name Blitz. These tablets contain approximately 36% by weight of isomalt and 23% of sorbitol.

Directly compressible compositions of base gum are also known, sold by the company SPI PHARMA under the name PHARMAGUM™S, which comprise approximately 75% by weight of sorbitol and 25% by weight of gum base. These compositions result in chewing-gum tablets which disintegrate and break up when chewing begins.

Wiser for this observation, and seeking to improve the state of the art, the Applicant endeavoured to produce a sugarfree chewing-gum tablet based on polyols, and essentially on sorbitol, which is the least expensive powdered polyol, on gum base and on liquid or powdered flavourings, which can contain intense sweeteners, or one or more food lubricants and a flow agent, and which does not exhibit the drawbacks of the prior art.

After many trials, it is to the Applicant's credit that it achieved this aim, by developing a particular formulation and an adapted process for obtaining essentially sorbitol-based sugarfree chewing-gum tablets which do not disintegrate and do not break up when chewing begins.

The invention therefore, firstly, relates to a sugarfree chewing-gum tablet comprising more than 25% by weight of gum base and a powdered sweetener containing at least 40%, preferably at least 50%, of powdered sorbitol, which does not disintegrate, does not break up and does not crumble when chewing begins, unlike the chewing-gums described in WO 02/78459.

The sweetener consists of at least 40%, preferably at least 50%, by weight of sorbitol in the form of a powder with a fine granulometry, combined with one or more powdered polyols with a fine granulometry, chosen from the group consisting of sorbitol, mannitol, maltitol, xylitol, erythritol, lactitol and isomalt, alone or mixed with one another.

For the purpose of the present invention, the term “fine granulometry” is intended to mean an average particle diametre of the order of 20 to 120 micrometres. These values can be determined using a Coulter® Laser LS 130 particle size analyzer, equipped with a Fourier optical cell and a dry phase module, by determining the size volume distribution of the pulverulent polyol particles by laser diffraction.

As regards the proportions of sweetener in the tablet, amounts of 50 to 75%, preferably 60 to 74%, and even more preferably 60 to 73% by weight are preferred. According to a preferred variant of the invention, the sweetener is present in the tablet in an amount of 60 to 70% by weight.

According to an advantageous variant of the invention, the sweetener consists of a binary or ternary mixture of powdered polyols comprising mainly sorbitol. Use may advantageously be made of a mixture of sorbitol with xylitol, mannitol or maltitol.

Very good results have been obtained with a sweetener comprising a mixture of 80 to 90% by weight of powdered sorbitol and 10% by weight of powdered xylitol, mannitol or maltitol.

By way of indication, use may be made of polyols with a fine granulometry, such as NEOSORB® P100T, XYLISORB® 90, MANNITOL 35 or MALTISORB® P35 sold by the Applicant.

As regards the gum base, any commercially available gum base suitable for preparing chewing-gums by direct compression may be used. By way of example, mention may be made, in particular, of the gum base sold by CAFOSA Gum S/A under the name ARTICA-T.

The gum base will be present in the tablet at a content of more than 25% by weight, preferably 25 to 50%, even more preferably 26 to 40%, and better still 27 to 30% by weight.

The chewing-gum tablet may also contain at least one compound chosen from food lubricants such as in particular magnesium stearate, calcium stearate, stearic acid or carboxymethylcellulose, flow agents such as, for example, silica, flavourings, dyes, intense sweeteners such as aspartame, acesulfame K, alitame, neotame, sucralose, saccharin or neohesperidin DC, pharmaceutical active agents, minerals plant extracts, antioxidants, and indigestible fibre, for instance oligosaccharides such as fructo-oligosaccharides, and indigestible fibre such as Fibersol® sold by the company Matsutani, or else Nutriose® FB sold by the Applicant. These excipients may be included directly in the powdered sweetener, or may be added separately.

The Applicant has, moreover, confirmed the importance of using powdered ingredients for preparing tablets according to the invention, by observing that, once more than 10% of polyol (maltitol, sorbitol or glycerol, alone or mixed with one another) syrup is used, it is not possible to obtain chewing tablets according to the invention, that is to say which do not disintegrate and do not crumble when chewing begins. The tablets according to the invention will therefore preferably contain less than 10% by weight of polyol syrup, and in particular of sorbitol, maltitol and/or glycerol syrup.

The invention also relates to a chewing-gum powder for obtaining the chewing-gum tablets according to the invention by compression.

More precisely, said chewing-gum powder comprising more than 25% by weight of gum base and a powdered sweetener is characterized in that said sweetener comprises at least 40%, and preferably at least 50%, of powdered sorbitol. According to an advantageous variant, said powder comprises more than 25%, preferably 25 to 50%, even more preferably 26 to 40%, and better still 27 to 30% by weight of gum base, and 50 to 75%, preferably 60 to 74%, and better still 60 to 73% by weight of a powdered sweetener comprising at least 40%, preferably 50%, of sorbitol.

According to a preferred variant of the invention, said powder comprises 27 to 30% by weight of gum base, and 60 to 73% by weight of a sweetener comprising sorbitol alone, or mixed with 10% of a polyol chosen from mannitol, xylitol, maltitol and isomalt, and also a lubricant, at least one flavouring, at least one intense sweetener and silica.

The invention relates, secondly, to a process for producing a sugarfree chewing-gum tablet comprising more than 25% by weight of gum base, a powdered sweetener comprising at least 40%, and preferably at least 50% by weight of powdered sorbitol, said tablet not disintegrating and not crumbling when chewing begins, comprising the steps of:

mixing the molten gum base and the powdered sweetener until a fine powder is obtained, and

cooling the powder obtained and compressing the cooled powder.

The gum base is melted so as to soften it, by any means known to those skilled in the art. By way of example, a microwave oven may be used.

The mixing of powdered sweetener and of gum base is carried out, for example, in a jacketed mixer, until a fine powder is obtained.

According to a preferred variant of the process according to the invention, the mixture is preheated to a temperature of approximately 80° C. In this case, it is not necessary to pre-melt the gum base, which can be used directly in the form of pellets.

The mixture can then be ground, if necessary, that is to say if aggregates are observed in the powder, by any means known to those skilled in the art, and then optionally sieved so as to remove the particles which are too fine and which can impair the flow of the powder, and/or the particles which are too large and which can impair the filling of the compression matrix. By way of example, it will be preferable for the powder to be compressed to have a granulometry between 50 and 2000 micrometres, preferably between 100 and 1000 micrometres. This granulometry is determined by successive sieving on rotary sieves equipped with a metal sheet.

The optionally ground and sieved mixture can then have any excipient, such, as, for example, flavourings, intense sweeteners, lubricants, indigestible fibre, pharmaceutical active agents or flow agents, added to it.

This mixture is then cooled by any means known to those skilled in the art. The mixture is preferably cooled to a final temperature of less than 25° C., preferably less than 20° C., and even more preferably of the order of 10° C.

This cooled mixture can then be directly compressed on an alternating press for example, it being possible to use any material for direct compression in order to implement the invention. A press equipped with concave punches will preferably be used.

The chewing-gum tablets according to the invention can also be sugar-coated by any technique at the disposal of those skilled in the art. Reference may be made to known methods using sugars or polyols, such as, for example, the sugar-coating processes described in patents EP 201,412 B1, EP 625,311 B1 and EP 774,210 B1, of which the Applicant is the proprietor, this list being in no way limiting.

The invention will be understood more clearly on reading the examples below, which are intended to be only non-limiting illustrations.

### EXAMPLE 1

### Preparation of a Sugarfree Chewing-Gum Tablet According to the Invention

a. Sorbitol-Mannitol Mixture

Formula

| | Ingredients |
|---|---|
| | by weight |
| Gum base (ARTICA T/CAFOSA) | 30.0% |
| NEOSORB ® P 100T | 54.3% |
| powdered Sorbitol | |
| Mannitol 35 | 10.0% |
| Mint flavouring | 3.0% |
| Menthol | 1.0% |
| Aspartame | 0.2% |
| Magnesium stearate | 1.0% |
| Silica (Aerosil 200) | 0.5% |

Procedure

The gum base in the form of pellets, the powdered sorbitol and the mannitol are introduced into a Z-arm mixer preheated to 85° C.

Mixing is carried out for approximately 5 minutes until a fine powder is obtained.

If necessary, the mixture is sieved to remove the aggregates.

The powder is cooled.

The flavourings, the aspartame, the magnesium stearate and the silica are added and the mixture is compressed on a Frogerais alternating press equipped with concave punches 13 mm in diametre.

b. Sorbitol-Xylitol Mixture

Formula

| | Ingredients |
|---|---|
| | by weight |
| Gum base (ARTICA T/CAFOSA) | 28.0% |
| NEOSORB ® P 100T | 56.3% |
| powdered Sorbitol | |
| XYLISORB ® 90 powdered xylitol | 10.0% |
| Mint flavouring | 3.0% |
| Menthol | 1.0% |
| Aspartame | 0.2% |
| Magnesium stearate | 1.0% |
| Silica (Aerosil 200) | 0.5% |

Procedure:

Identical to a), replacing the mannitol with xylitol.

c. Sorbitol-Maltitol Mixture

Formula

| | Ingredients |
|---|---|
| | by weight |
| Gum base (ARTICA T/CAFOSA) | 28.0% |
| NEOSORB ® P 100T powdered Sorbitol | 56.3% |
| MALTISORB ® P35 powdered maltitol | 10.0% |
| Mint flavouring | 3.0% |
| Menthol | 1.0% |
| Aspartame | 0.2% |
| Magnesium stearate | 1.0% |
| Silica (Aerosil 200) | 0.5% |

Procedure:

Identical to a), replacing the mannitol with maltitol.

The chewing-gum tablets according to a, b or c do not disintegrate, do not crumble and do not break up when chewing begins, after which time the usual elastic texture of a conventional chewing-gum is obtained.

d. Sorbitol Alone

Formula

| | Ingredients |
|---|---|
| | by weight |
| Gum base (ARTICA T/CAFOSA) | 28.0% |
| NEOSORB ® P 100T powdered Sorbitol | 66.8% |
| Mint flavouring | 3.0% |
| Menthol | 1.0% |
| Aspartame | 0.2% |
| Magnesium stearate | 1.0% |

Procedure

The pre-molten (microwave 5 min/1000 W) gum base and the powdered sorbitol are introduced into a Z-arm mixer.

Mixing is carried out for approximately 25 to 60 minutes, until a fine powder is obtained.

If necessary, sieving is performed in order to remove the aggregates.

The flavourings, the aspartame, the magnesium stearate and the silica are added and the mixture is compressed on a Frogerais alternating press equipped with flat punches 10 mm in diametre.

e. Mixture of Sorbitol and Indigestible Fibre

Formula

| | Ingredients |
|---|---|
| | by weight |
| Gum base (ARTICA T/CAFOSA) | 28.0% |
| NEOSORB ® P 100T powdered Sorbitol | 63.3% |
| NUTRIOSE ® FB indigestible fibre | 3.5% |
| Mint flavouring | 3.0% |
| Menthol | 1.0% |
| Aspartame | 0.2% |
| Magnesium stearate | 1.0% |

Procedure: Identical to d).

The tablets according to d) and e) do not disintegrate and do not crumble when chewing begins. No problem of adhesion during the compression is observed.

### EXAMPLE 2

### Preparation of Sugarfree Chewing-Gum Tablets According to the Invention and Comparison with a Composition of the Prior Art

Chewing-gum tablets according to the invention, comprising a sweetener containing at least 40% of sorbitol with a fine granulometry were prepared according to the following formulae 1 to 7. Tablets were prepared under the same conditions with a ready-to-use powder in which the sweetener consists mainly of isomalt. The tablets were then subjected to a tasting panel, which was asked to evaluate the texture of the tablets in the mouth, and to pinpoint the preferred formula.

| | Formula 1 | Formula 2 | Formula 3 | Formula 4 | Formula 5 | Formula 6 | Formula 7 |
|---|---|---|---|---|---|---|---|
| NEOSORB ® P60W | 60.9 | 59.4 | 57.9 | 59.9 | 55.9 | 56.4 | 50.9 |
| ARTICA T | 30.0 | 30.0 | 33.0 | 30.0 | 30.0 | 33.0 | 30.0 |
| Xylitol 90 | — | — | — | — | 5.0 | — | 10.0 |
| LYCASIN ® 80/55 | — | 1.5 | — | — | — | 1.5 | — |
| HDS | | | | | | | |
| Glycerol | — | — | — | 1.0 | — | — | — |
| Calcium stearate | 1.5 | 1.5 | 1.5 | 1.5 | 1.5 | 1.5 | 1.5 |
| Aspartame Taste Tech | 1.0 | 1.0 | 1.0 | 1.0 | 1.0 | 1.0 | 1.0 |
| Acesulfame K | 0.3 | 0.3 | 0.3 | 0.3 | 0.3 | 0.3 | 0.3 |
| Peppermint flavouring | 2.0 | 2.0 | 2.0 | 2.0 | 2.0 | 2.0 | 2.0 |
| Firmenich | | | | | | | |
| Menthol IFF | 2.0 | 2.0 | 2.0 | 2.0 | 2.0 | 2.0 | 2.0 |
| Peppermint AM Todd | 1.0 | 1.0 | 1.0 | 1.0 | 1.0 | 1.0 | 1.0 |
| “Crystal White” AM | 0.8 | 0.8 | 0.8 | 0.8 | 0.8 | 0.8 | 0.8 |
| Todd | | | | | | | |
| Silica Sypernat 50S | 0.5 | 0.5 | 0.5 | 0.5 | 0.5 | 0.5 | 0.5 |
| Total | 100.0 | 100.0 | 100.0 | 100.0 | 100.0 | 100.0 | 100.0 |

Results:

All the powders tested have a satisfactory flow, the addition of silica making it possible to maintain the fluidity of the powder after addition of the liquid flavouring.

After tasting, all the tablets according to the invention exhibit a bound chewing-gum texture in the mouth, like a conventional chewing-gum. These tablets were preferred by the tasting panel, compared to the isomalt base tablet; which was judged to be less satisfactory due to a, crumbly texture in the mouth, and harder than the tablets according to the invention. No preference for said isomalt base tablet was expressed, whereas the tablets according to the invention were preferred in a discriminating manner, without significant differences between them.

1. Sugarfree chewing-gum tablet comprising more than 25% by weight of gum base and a powdered sweetener comprising at least 40%, and preferably at least 50%, by weight of powdered sorbitol, which does not disintegrate, does not break up and does not crumble when chewing begins.

2. Tablet according to claim 1, wherein the powdered sweetener comprises, besides sorbitol, one or more powdered polyols with a fine granulometry, chosen from the group consisting of sorbitol, mannitol, maltitol, xylitol, erythritol, lactitol and isomalt, alone or mixed with one another.

3. Tablet according to claim 1, wherein the sweetener consists of a mixture of two polyols chosen from sorbitol and xylitol, sorbitol and mannitol, or sorbitol and maltitol.

4. Tablet according to claim 1, wherein said sweetener has an average granulometry of between 20 and 120 micrometres.

5. Tablet according to claim 1, also comprising at least one compound chosen from a lubricant, a flavouring, a dye, a pharmaceutical active agent and an indigestible fibre.

6. Tablet according to claim 1, comprising less than 10% by weight of polyol syrup, and preferably less than 10% by weight of sorbitol, maltitol and/or glycerol syrup.

7. Tablet according to claim 1, comprising 25 to 50%, preferably 26 to 40% by weight of gum base, and 50 to 75%, preferably 60 to 74%, and even more preferably from 60 to 73% by weight of sweetener.

8. Process for producing a chewing-gum tablet according to claim 1, comprising the steps of:
mixing the molten gum base and the powdered sweetener until a fine powder is obtained,
cooling the powder,
compressing the cooled powder.

9. Process according to claim 8, wherein the mixing of the non-molten gum base and the powdered sweetener is carried out in a mixer preheated to more than 70° C., and preferably to more than 80° C.

10. Chewing-gum powder for compression, comprising more than 25% by weight of gum base and a powdered sweetener comprising at least 40%, and preferably at least 50%, by weight of powdered sorbitol, which makes it possible to obtain chewing-gum tablets which do not disintegrate, do not break up and do not crumble when chewing begins.
